(19) United States
(12) Patent Application Publication
(10) Pub. No.: US 2002/0196569 A1
(43) Pub. Date: Dec. 26, 2002

(54) Mechanical device for producing angular movement of an optical element

(75) Inventors: Shaul Eliahu-Niv, Kiryatono (IL); Reuven Dahan, Zuryigal (IL); Yuval Artstein, Tel Aviv (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: REDC OPTICAL NETWORKS LTD.

(21) Appl. No.: 09/976,028

(22) Filed: Oct. 15, 2001

Related U.S. Application Data
(60) Provisional application No. 60/300,096, filed on Jun. 25, 2001.

(51) Int. Cl. G03H 1/30; G02B 5/22; G02B 7/00

(52) U.S. Cl. 359/892; 359/25

(57) ABSTRACT

A mechanical device for tilting an optical element consisting of one or more actuators attached to a support element supporting an optical filter or other optical device is provided. In one preferred embodiment of the present invention, a rigid support element is free to move at one end, or is attached by a hinge at one end to an actuator while movement of its second end is restrained, resulting in tilting of the support element when the actuator is activated. In another embodiment of the present invention, a deformable support element is rigidly attached to the actuator at one end while movement of the second end of the support element is restrained, resulting in bending of the support element and tilting of the optical element upon movement of the actuator. In yet another embodiment, a deformable support element is rigidly attached to two actuators, resulting in bending of the support element when the actuators are activated. The actuator is preferably a piezoelectric device that is activated by application of an electrical voltage. Alternatively, the actuator is thermally, electrostatically, electromagnetically, or magnetically activated. A method is provided of filtering an incident light beam based on tilting a filter for passing light in the incident light beam within a predetermined characteristic wavelength band that is a function of the angle of incidence of the incident light beam upon the filter. The filter is tilted to change the angle of incidence by activating an actuator that is attached to and changes the shape or orientation of the support element whereon the filter is mounted. Preferably, the filter is tilted in response to a feedback signal indicative of the angular position of the filter. Preferably, the feedback signal is based on light reflected from the filter. Alternatively, the feedback signal is based on light transmitted by the filter, or is a signal from a sensor responsive to movement of the filter or of a mechanical element associated therewith.

### FIELD AND BACKGROUND OF THE INVENTION

The present invention relates to a mechanical device for producing the precise, discrete or continuous angular movement or swinging of a mount supporting an optical element such as a mirror or an optical filter such as those used in fiber optics systems.

In recent years, optical fiber technology for telecommunication has progressed rapidly. While the theoretical transmission capacity of the single-mode optical fiber has been recognized in the industry as extremely high from the time of its initial introduction, much of the capacity has not been utilized. For the increasing demand for bandwidth, such as in the transmission of video images and graphics, much attention has been directed toward the maximal utilization of the bandwidth of the single-mode fiber. The common schemes for increasing bandwidth utilization include time division multiplexing or wavelength division multiplexing (WDM).

In a WDM system, multiple signal sources emitting at different wavelengths are coupled into the same single-mode fiber by means of a multiplexer. At the desired destination, the multiple wavelength signals are demultiplexed and channeled to receivers. A tunable filter may be used to select any specific wavelength out of the multiple wavelengths that are carried by the single-mode fiber.

Tunable filters as taught by the prior art employ Fabry-Perot interference, Mach-Zehnder interference, acoustic tuning, a tunable ring resonator, and thin film interference. U.S. Pat. No. 5,212,745 discloses a tunable filter design constructed with a Fabry-Perot etalon. This type of tunable filter can have a very narrow bandwidth, but is very sensitive to temperature change. Other deficiencies include sensitivity to voltage variations as well as non-linearity of the mechanized PZT actuator and the Fabry Perot filter optics. These deficiencies necessitate frequent calibration of the filter when it is used as an optical channel analyzer. One way to overcome these deficiencies is to use an expensive multi-wavelength reference device, as taught in U.S. Pat. No. 5,892,582, for calibration. This solution, however, requires a unique installation configuration such as an optical switch to alternately scan the DWDM (Dense Wavelength Division Multiplexing) spectrum and the known wavelengths of the multi-wavelength reference. In addition, this procedure requires interrupting the normal working mode, calibrating, and then resuming the normal working mode. It is not possible, with this procedure, to work continually in real time feedback mode. Other tuning methods such as some of those mentioned above are disclosed in Chapter 4 of Fiber Optic Networks, by Paul E. Green. Jr., Prentice-Hall, Englewood Cliffs, N.J., 1993.

Each of the above-described tunable filters is deficient to some extent in its level of precision, extent of tuning controllability and inability to provide continuous wavelength passband variability. It is therefore desirable to provide an improved tunable filter system with improved precision and controllability characteristics.

As is known to those skilled in the art, many filters have the characteristic property that their wavelength band varies with the angle of incidence of the incident light to the normal incidence direction of the filter. An interference type filter has such characteristic, as illustrated in FIG. 1, which is taken from Lee, U.S. Pat. No. 5,781,341. which patent is incorporated by reference for all purposes as if fully set forth herein. Thus, if λ₀ is the center frequency wavelength of light that is passed by filter 20 at zero angle of incidence (that is, when light is directed to the filter along direction 30), then the center frequency wavelength λ_{θ} of the characteristic wavelength band of incident light at angle of incidence θ is given by the following equation:

λ_{θ}=λ₀(1−a sin² θ)^{½}

where a is a coefficient related to the effective refractive index of thin films in the thin film interference filter 20. A typical value of a is 0.35.

A representative description of the closest prior art to the present invention can be found, for example, in the Lee patent from which FIG. 1 is taken. This patent describes a motorized tunable optical filter which utilizes the rotation of a cam by a stepping motor to tilt a thin film interference filter, thereby changing the center frequency of the filter passband.

In this motorized tunable optical filter, a stepping motor rotates a cam about an off-center axis, resulting in the longitudinal displacement of a bearing in contact with the surface of the cam. The displacement of the bearing, which is attached to a filter holder and optical filter element which pivot on a shaft, causes the filter holder and filter element to pivot. The filter element is placed between an input collimator carrying an input light beam and an output collimator which carries the output beam to the output optical fiber. As the filter element pivots, the angle of incidence of the input light beam on the filter element changes, resulting in a change in the characteristic wavelength band of the filter element. The desired angle of rotation of the filter element and thus the characteristic wavelength band can be chosen by means of an electronic circuit which is used to control the microstepping of the motor.

There are several disadvantages associated with the above-described electrical-mechanical device of the prior art for producing an angular movement, including:

a) The device of the prior art is complex and expensive to manufacture.

b) The device is not capable of providing precise, fine control of the filter angle, being subject to error due to its mechanical complexity.

c) The device of the prior art is incapable of providing continuous wavelength passband variability, being limited to providing discrete wavelength bands as a consequence of to the discrete microsteps which characterize the microstep motor operation.

There is therefore a recognized need for, and it would be highly advantageous to have, a device for producing angular movement of an optical element such as a mirror or an optical filter which eliminates the need for an expensive and complicated calibration device, while being simple to assemble and inexpensive to manufacture and while providing continuous wavelength passband variability combined with sensitive, precise angular control of the optical element.

### SUMMARY OF THE INVENTION

According to the present invention there is provided a device for tilting of an optical element, including a mount attached to a support element upon which the optical element is mounted and at least one actuator attached to the support element for moving the support element in a manner that tilts the mount and the optical element.

The scope of the term “tilting”, as used herein, encompasses both discrete angular motion (static mode), as in the prior art device of Lee, and continuous angular motion (dynamic or sweeping mode).

The present invention relates to a mechanical device for producing angular movement of an optical element such as a mirror or an optical filter. The device can be used either as an angular positioner for precise mirror or optical filter alignment or as a dynamic angular deflecting driver for many other optical components or systems. One preferred embodiment of the present invention consists of a mechanical device having a piezoelectric actuator and an elastic deformable member. When activated, the actuator mechanical output displacement produces a linear driving force between the actuator output end and the deformable elastic member, bending the elastic member, thereby tilting the optical device which is mounted on it. Another embodiment of the present invention provides a device for producing an angular movement of an optical element consisting of a bending actuator hinged to a rigid member element which move in tandem to produce a mutually angular deflection as the device output.

The various preferred embodiments of the device are based on simple linear and cantilever mechanical actuators which, when activated by piezoelectric or other suitable means, provide a precision mechanical output to a support element supporting a device such as an interference optical filter and filter mount, resulting in tilting of the optical filter, thereby changing its characteristic light passband frequency. This device output can be controlled in open loop mode or with feedback based on a measured parameter such as the angular position of the optical device. The various embodiments of the device also are based on well-designed mechanical amplifiers to produce maximum output angular displacement from a given actuator output.

It is an object of the present invention to provide a substantial mechanical angular deflection of an optical device support via angular mechanical amplification.

It is a further object of the present invention to provide a mechanical angular driving device which has the ability to deflect a deformable optical support element in a linear or angular traverse, thereby attaining the desired filter mount and optical filter angle with high precision and reliability.

It is a further object of the present invention to provide a method of optical filter tilt angle on-line direct measurement that is simpler than the method taught in the prior art.

It is a further object of the present invention to provide a mechanical angular driving device which has the ability to drive a rigid optical element support element over a wide, continuous range of angular positions (several tens of degrees) to a fixed desired angular position with high precision (a small fraction of a degree) and reliability.

It is a further object of the present invention to provide a mechanical angular driving device which has the capability of closed loop operation by continuous measurement and feedback of the angular position of the optical device.

It is a further object of the present invention to provide a mechanical angular driving device, which can be manufactured by means of Micro-Electro-Mechanical-Systems (MEMS) manufacturing techniques.

It is a further object of the present invention to provide a mechanical angular driving device which has the advantage of low power consumption.

It is a further object of the present invention to provide a mechanical angular driving device which has the advantages of high durability while allowing low cost mass production.

It is a further object of the present invention to provide a tunable filter whose input optical signal is provided via a collimator and whose optical output is transformed to an electrical signal by using a detector whose surface is coated by an antireflection layer. The optical output of the filter is passed through a pupil to reduce background noise.

The present invention successfully addresses the shortcomings of the existing technologies by providing a design for enabling on-line optical element angle measurement without requiring an expensive and complicated calibration device, while increasing the precision of optical element angular positioning, reducing power consumption, providing high durability, and reducing manufacturing cost.

### BRIEF DESCRIPTION OF THE DRAWINGS

The present invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the present invention, the description taken with the drawings making apparent to those skilled in the art how the several forms of the present invention may be embodied in practice.

In the drawings:

FIG. 1 (prior art) is a schematic diagram of a thin film interference type optical filter illustrating the angle of incidence of incoming light.

FIG. 2 is a sectional side view of the mechanical angular driving device according to one embodiment of the present invention consisting of a piezoelectric elongate actuator at rest in which the deformable elastic support element is in its natural configuration;

FIG. 3 is a sectional side view of the device of FIG. 2 in which the actuator is activated and the attached deformable elastic support element is in a bent configuration;

FIG. 4 is a perspective view of the device of FIG. 2 showing the position of the optical filter mount and the optical filter.

FIG. 5 is a perspective view of the device of FIG. 2 with the actuator activated as in FIG. 3, showing the position of the optical filter mount and the optical filter.

FIG. 6 is a sectional side view of the mechanical angular driving device according to a second embodiment of the present invention consisting of a piezoelectric bimorph strip cantilever bending actuator element at rest with the attached deformable elastic support element in its natural configuration;

FIG. 7 is a sectional side view of the device of FIG. 6 in which the piezoelectric bimorph strip cantilever bending actuator element is activated and the attached deformable elastic support element is in a bent configuration;

FIG. 8 is a sectional side view of the mechanical angular driving device according to a third embodiment of the present invention consisting of two piezoelectric bimorph strip cantilever bending actuator elements in the deactivated state with a deformable elastic support element attached in its natural orientation;

FIG. 9 is a sectional side view of the device of FIG. 8 in which the piezoelectric bimorph strip cantilever bending actuator elements are activated and the attached deformable elastic support element is in a bent configuration;

FIG. 10 is a sectional side view of a fourth embodiment of the present invention consisting of a single piezoelectric bimorph strip cantilever bending actuator element in the deactivated state, hinged to a rigid support element at rest.

FIG. 11 is a sectional side view of the device of FIG. 10 in which the piezoelectric bimorph strip cantilever bending actuator element is activated and the rigid support element is angularly displaced;

FIG. 12 is a sectional side view of a fifth embodiment of the present invention in which a single bimorph strip cantilever bending actuator element is mounted vertically on the device support base, directly displacing the attached support element.

FIG. 13 is a sectional side view of a sixth embodiment of the present invention in which a bimorph strip cantilever bending actuator, which is attached to a deformable element, is alternately at rest (13a), actuated to bend downward (13b), and actuated to bend upward (13c).

FIG. 14 is a sectional view of a seventh embodiment of the present invention in which a bimorph strip cantilever bending actuator, which is attached to a mechanical linkage support element, is alternately at rest (14a), actuated to bend upward (14b), and actuated to bend downward (14c).

FIG. 15 is a schematic diagram of an apparatus for providing a feedback signal for controlling an angular position of an optical filter.

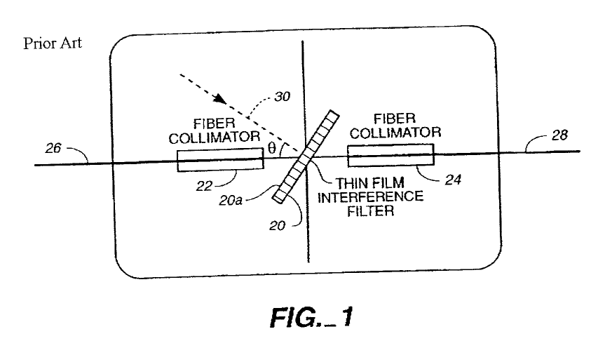

### DESCRIPTION OF THE PREFERRED EMBODIMENTS

The present invention is a mechanical angular driving device which is based on simple mechanical actuators which, when activated by a piezoelectric actuator or other suitable means, provide a precision mechanical output to an optical filter support element or other device, resulting in angular deflection of the element or device, which can be controlled in open loop mode or in closed loop feedback mode based on the measurement of a relevant parameter such as the optical filter geometric angle.

The principles and operation of the mechanical angular driving device according to the present invention may be better understood with reference to the drawings and the accompanying description.

Before explaining at least one embodiment of the present invention in detail, it is to be understood that the present invention is not limited in its application to the details of construction and the arrangement of the components set forth in the following description or illustrated in the drawing. The present invention is capable of other embodiments or of being practiced or carried out in various ways. Also, it is to be understood that the phraseology and terminology employed herein is for the purpose of description and should not be regarded as limiting

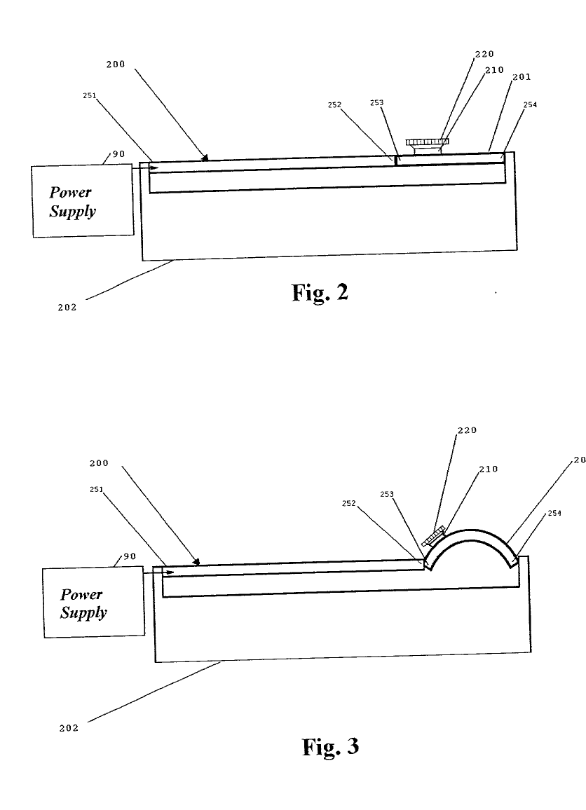

The preferred embodiments of the present invention will now be described with reference to FIGS. 2-15, which illustrate a variety of constructions thereof suitable for different configurations. Referring now to the drawings, FIG. 2 and FIG. 3 illustrate one preferred embodiment of the apparatus constructed in accordance with the present invention. As shown in FIG. 2 and FIG. 3, there is seen an apparatus for mechanical angular driving and operative in accordance with a preferred embodiment of the present invention and consisting of a base 202, an elongate piezoelectric actuator element 200 attached to base 202, and a deformable elastic support element 201 placed between actuator 200 and base 202. Piezoelectric actuator element 200 is mounted at a first end 251 thereof onto base 202, while a second end 252 is attached to a first end 253 of deformable elastic support element 201. In accordance with the present invention, first end 253 of deformable elastic member 201 is secured as by gluing, clamping or by other suitable means to second end 252 of piezoelectric actuator element 200 adjacent thereto for motion together in the longitudinal direction. A second end 254 of deformable plastic member 201 is similarly attached to stationary base 202 of the device. Piezoelectric actuator element 200 preferably is of conventional multi layer construction.

In the presently described preferred embodiment of the present invention, as well as in the further preferred embodiments described below, mounting of optical filter 220 on the support element is the mechanical association of optical filter 220 with the support element, such that tilting of the surface of the support element causes optical filter 220 to tilt. In the various embodiments of the present invention, this mechanical association is accomplished either by directly mounting optical filter 220 on the support element or by indirectly mounting optical filter 220 on a separate mounting device which in turn is mounted on the support element.

The indirectly mounted optical filter configuration of the presently described preferred embodiment of the present invention is illustrated in FIGS. 2 & 3, wherein optical filter 220 is mounted upon an optical element mount 210, which is attached to and supported by deformable elastic support element 201, such that the degree of tilt of optical filter 220 is determined by the configuration of the body of deformable elastic support element 201. Similarly, in the examples of the further preferred embodiments of the present invention described herein, only the indirectly mounted optical filter configuration is illustrated and described.

Piezoelectric actuator element 200 is activated by the application of an electrical voltage supplied by a power supply 90. In the preferred embodiments of the present invention, the actuator is characterized by being physically attached to the support element that it is moving, while possessing the capability of changing shape when activated, including bending and elongation.

It is a particular feature of the present invention that piezoelectric actuator elements of the type employed herein display a generally linear and longitudinal mechanical displacement in response to voltage inputs within part of their operative range. The displacement-voltage characteristics can be calibrated and open loop control may be thus be employed. In addition, closed loop operation mode employing optical feedback control can be employed by continuous measurement and feedback to a control device having an adjustable set point for selecting the desired tilt angle, of a suitable optical element characteristic parameter that is dependent on the filter angle, such as the optical filter passband frequency.

FIG. 2 illustrates deformable elastic member element 201 in its natural configuration at rest when piezoelectric actuator element 200 is not activated. FIG. 3 illustrates deformable elastic member element 201 in a bent configuration when piezoelectric actuator element 200 is activated by application of an input voltage to the piezoelectric actuator element electrical input terminal Any desired position between the two extreme actuator positions illustrated in FIG. 2 and FIG. 3 may be obtained by the application of a suitable voltage to the piezoelectric actuator element electrical input terminal.

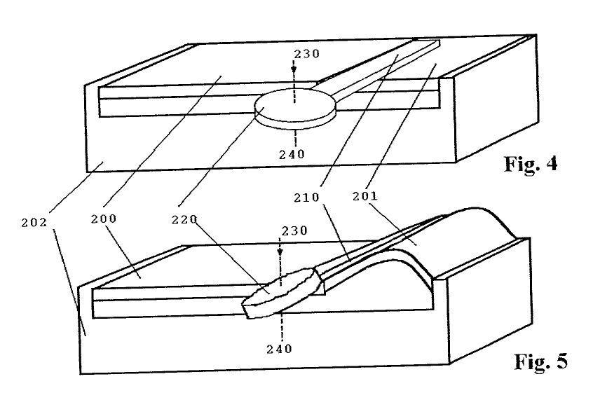

FIG. 4 illustrates the device of FIG. 2 in perspective view, with piezoelectric actuator element 200 in the non-activated state, showing mount 210 supporting optical filter 220 disposed to the side of the device, providing an unobstructed path for the input and output light beams 230, 240. FIG. 5 is a similar perspective view of the same device with piezoelectric actuator element 200 in the activated state, illustrating the tilting of mount 210 and optical filter 220. In FIGS. 2, 3 and 6-14 the mounts and optical filters are similarly disposed to the sides of the devices as depicted in FIGS. 4 and 5, providing unobstructed paths for input and output light beams 230, 240.

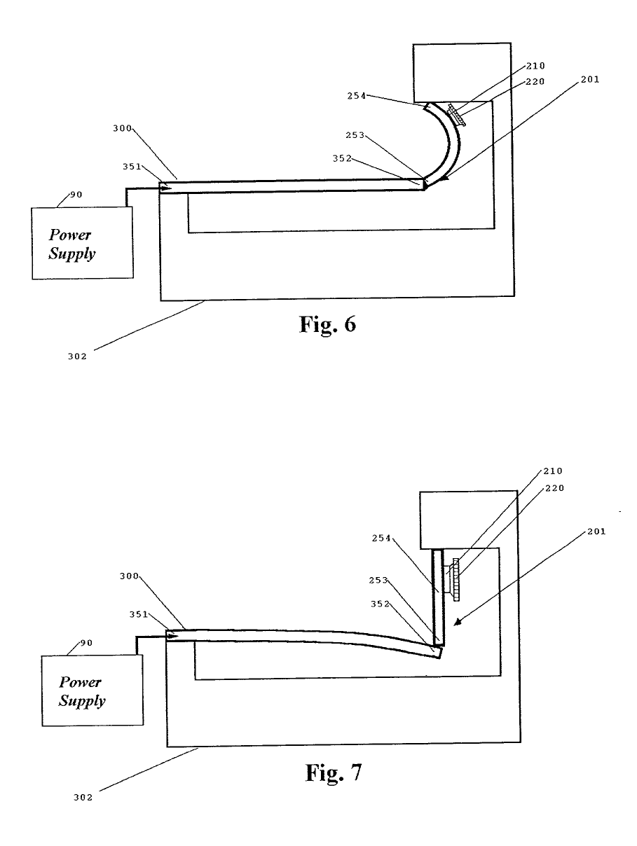

FIG. 6 is a schematic diagram of another preferred embodiment of the present invention in which there is seen a device for providing angular displacement which consists of a piezoelectric bimorph strip cantilever bending actuator 300 having a first end 351 mounted to a base 302 and a second end 352 connected to first end 253 of deformable elastic support element 201. Second end 254 of deformable elastic support element 201 is mounted to base 302. Piezoelectric bimorph strip cantilever bending actuator element 300 is activated by the application of an electrical voltage supplied by power supply 90. The application of an activation voltage to the piezoelectric bending actuator input results in the deflection of bimorph strip cantilever bending actuator 300 in the downwards direction in FIG. 7, causing deformable elastic support element 201 to straighten. Optical filter 220 is mounted upon optical element mount 210, which is attached to and supported by deformable elastic support element 201, such that the degree of tilt of optical filter 220 is determined by the configuration of the body of deformable elastic support element 201.

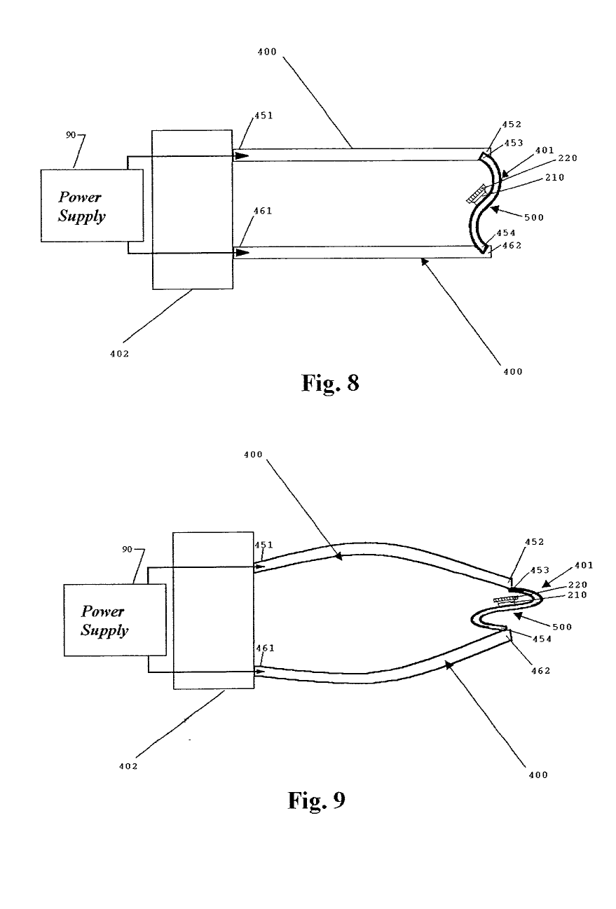

FIG. 8 illustrates yet another preferred embodiment of the present invention in which first ends 451, 461 of two piezoelectric bimorph strip cantilever bending actuators 400 are attached to a base 402, while second ends 452, 462 of actuators 400 are respectively attached to two ends 453, 454 of a single, S-shaped deformable element 401. Piezoelectric bimorph strip cantilever bending actuators 400 are activated by the application of an electrical voltage supplied by power supplies 90. Angular control of an optical device mounted at the center of single deformable element 401 and disposed at a center of bending plane 500 is achieved by supplying a suitable activation voltage to piezoelectric bending actuators 400, as illustrated in FIG. 9. Optical filter 220 is mounted upon optical element mount 210, which is attached to and supported by deformable elastic support element 401, such that the degree of tilt of optical filter 220 is determined by the configuration of the body of deformable elastic support element 201. In FIG. 9, symmetrical deformation of deformable elastic support element 401 is achieved by supplying identical amplitude and anti-phase input voltage to both bending elements 400. This preferred embodiment of the present invention provides the unique capability of controllable deformation of the deformable elastic support element 401 which is achieved by supplying different activation voltages and phases to bending actuators 400.

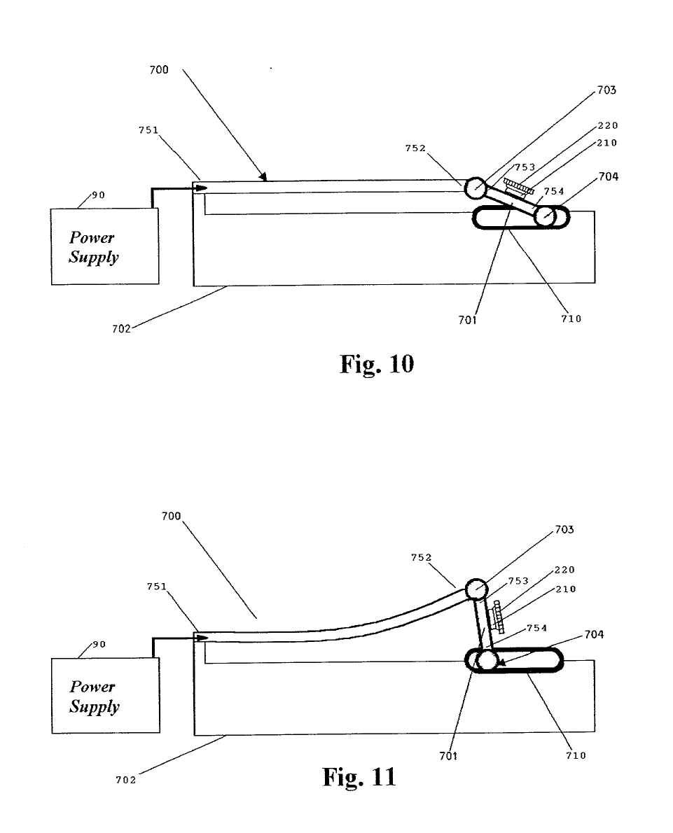

FIG. 10 is a schematic diagram of yet another preferred embodiment of the present invention in which a piezoelectric bending actuator 700 is connected by a hinge 703 to a rigid support element 701. As shown in FIG. 10, a first end 751 of piezoelectric bending actuator 700 is rigidly attached to a base 702 of the device, while a second end 752 of piezoelectric bending actuator 700 is connected to a first end 753 of rigid support element 701 by hinge 703, which allows rigid support element 701, which functions as the support for an optical element such as an optical filter, to pivot at the connection point with piezoelectric bending actuator 700. A second end 754 of rigid support element 701 is linked to base 702 by a guide pin 704 which is free to slide back and forth in the horizontal plane within a guide track 710 built into the top surface of base 702. Piezoelectric bending actuator element 700 is activated by the application of a suitable electrical voltage supplied by power supply 90. Piezoelectric bending actuator 700 and rigid support element 701 are arranged to produce an angular displacement with respect to the plane of base 702 of the device when piezoelectric bending actuator 700 is activated, as can be seen in FIG. 11. Optical filter 220 is mounted upon optical element mount 210, which is attached to and supported by rigid support element 701, such that the degree of tilt of optical filter 220 is determined by the displacement angle of support element 701. The displacement angle of rigid support element 701 produced is proportional to the activation voltage applied to piezoelectric bending actuator 700. Thus, the angular displacement of piezoelectric bending actuator 700 causes rigid member element 701, being pivotably connected at both ends, and having translational freedom in the horizontal plane of base 702 of the device while allowing the second end of rigid member element 701 to move back and forth between the two extreme positions of guide pin 704, to be angularly displaced with respect to base 702 of the device.

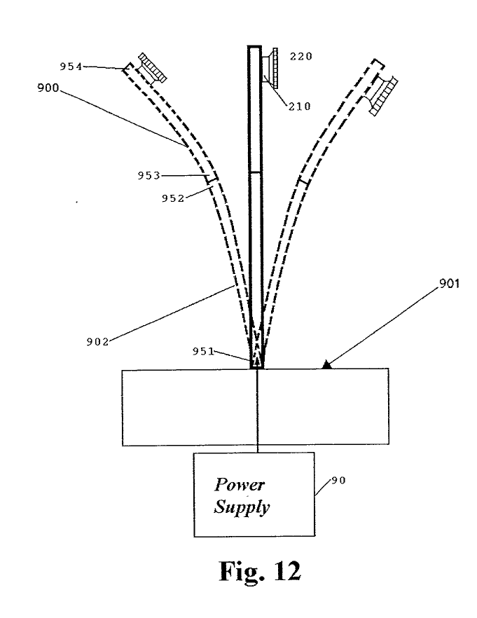

FIG. 12 is a schematic diagram of yet another preferred embodiment of the present invention in which a mechanical device for producing an angular movement of an optical element is shown. The device consists of a base 901. a piezoelectric bending actuator element 902, and a flexible extension support element 900, which functions as the support for the optical element mount. Piezoelectric actuator element 902 is mounted at a first end 951 to base 901 and at a second end 952 to a first end 953 of flexible extension element 900. A second end 954 of flexible extension element 900 is unattached and thus free to move, as shown in FIG. 12, as a result of the activation of piezoelectric bending actuator element 902. Piezoelectric bimorph strip cantilever bending actuator element 902 is activated by the application of an electrical voltage supplied by power supply 90. Optical filter 220 is mounted upon optical element mount 210, which is attached to and supported by flexible extension support element 900, such that the degree of tilt of optical filter 220 is determined by the angular orientation of flexible extension element 900.

Two working modes are possible for this embodiment of the device, the natural frequency mode and the static mode. In the natural frequency mode the piezoelectric actuator works as a vibrator which vibrates at the natural frequency of the combination of piezoelectric actuator element 902 and flexible extension element 900. In this mode the actuator is driven by an AC voltage whose frequency is the natural resonance frequency of piezoelectric actuator element 902 and flexible extension element 900 configured as one body. Flexible extension element 900 functions as a mechanical amplifier for the free end of piezoelectric actuator element 902. In this operating mode, a large tip displacement of the free end of flexible extension element 900 is achieved at the natural frequency. The length of flexible extension element 900 is preferably chosen to provide a natural resonance frequency when attached to piezoelectric actuator element 902 equivalent to the desired AC voltage supply frequency.

In the static operating mode, piezoelectric bending actuator element 902 is activated by the application of a constant DC voltage. resulting in angular deflection to a steady angle of actuator element 902 and flexible extension element 900. In this mode, flexible extension element 900 functions as a mechanical amplifier of the angular output of actuator element 902.

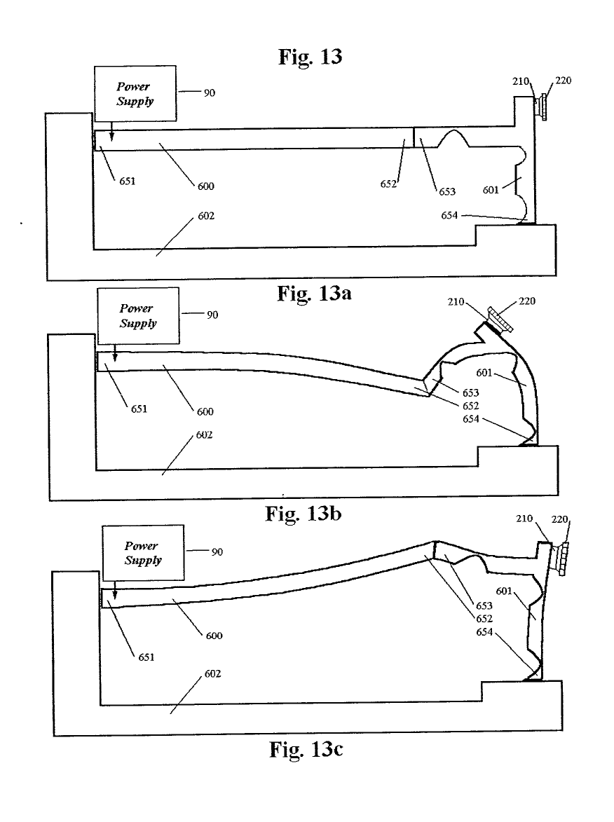

FIG. 13 is a schematic diagram of another preferred embodiment of the present invention in which there is seen a device for providing angular displacement which consists of a piezoelectric bimorph strip cantilever bending actuator 600 having a first end 651 mounted to a base 602 and a second end 652 connected to a first end 653 of a deformable elastic support element 601. A second end 654 of deformable elastic support element 601 is mounted to base 602. Piezoelectric bimorph strip cantilever bending actuator element 600 is activated by the application of an electrical voltage supplied by power supply 90. The application of an activation voltage to the piezoelectric bending actuator input results in the deflection of bimorph strip cantilever bending actuator 600 in the downward direction in FIG. 13b. causing deformable elastic support element 601 to bend downward. The application of an activation voltage of opposite polarity results in the deflection of bimorph strip cantilever bending actuator 600 in the upward direction in FIG. 13c, causing deformable elastic support element 601 to bend upward. Optical filter 220 is mounted upon optical element mount 210. which is attached to and supported by deformable elastic support element 601, such that the direction and degree of tilt of optical filter 220 is determined by the configuration of the body of deformable elastic support element 601.

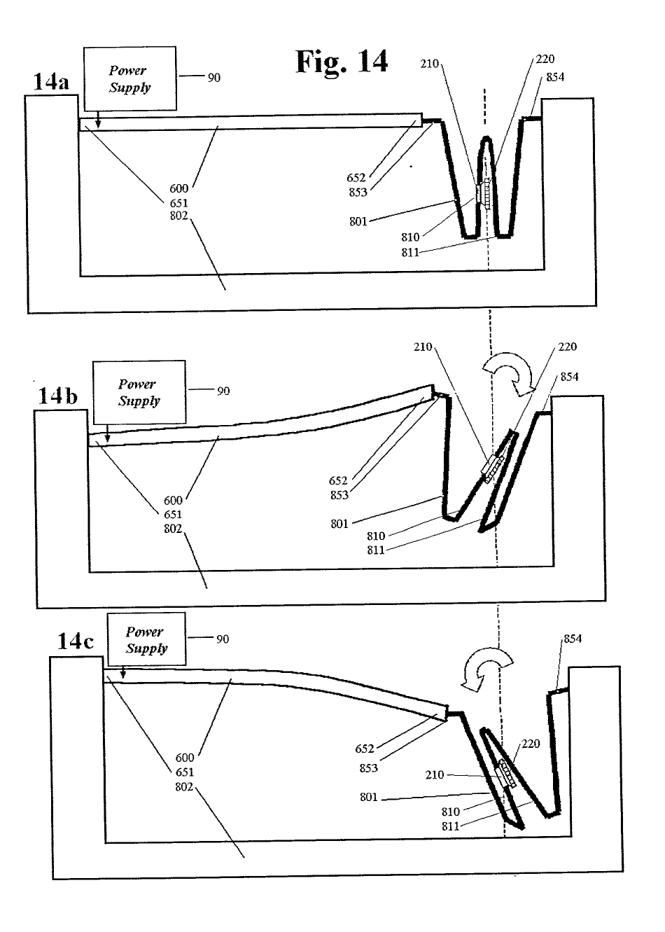

FIG. 14 is a schematic diagram of another preferred embodiment of the present invention in which there is seen a device for providing angular displacement which consists of piezoelectric bimorph strip cantilever bending actuator 600 having first end 651 mounted to a base 802 and second end 652 connected to a first end 853 of a deformable mechanical linkage support element 801. A second end 854 of deformable mechanical linkage support element 801 is mounted to base 802. Piezoelectric bimorph strip cantilever bending actuator element 600 is activated by the application of an electrical voltage supplied by power supply 90. The application of an activation voltage to piezoelectric bimorph strip cantilever bending actuator element 600 results in its deflection in the upward direction in FIG. 14b, causing deformable mechanical linkage support element 801 to deform as shown, with its two centrally-located links 810, 811 rotating in the clockwise direction. The application of an activation voltage of opposite polarity results in the deflection of bimorph strip cantilever bending actuator 600 in the downward direction in FIG. 14c, causing links 810, 811 of deformable mechanical linkage support element 801 to rotate in the counterclockwise direction. Optical filter 220 is mounted upon optical element mount 210, which is attached to and supported by links 810, 811 of deformable mechanical linkage support element 601, such that the direction and degree of tilt of optical filter 220 is determined by the orientation of links 810, 811.

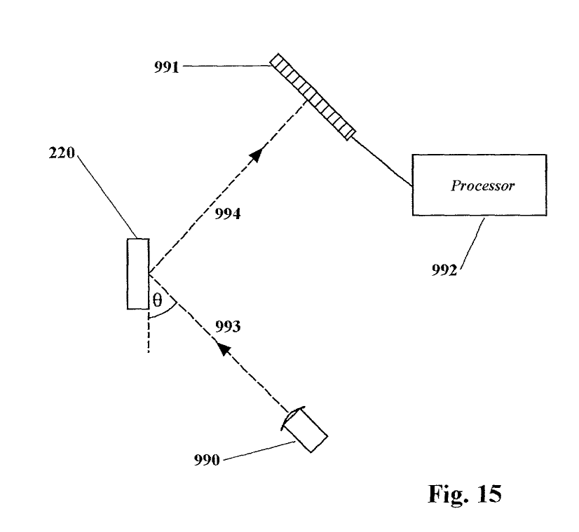

FIG. 15 is a schematic diagram of an apparatus for providing a feedback signal for controlling an angular position of optical filter 220. The apparatus is based on measuring the geometric angle of an optical filter, processing the result, and providing a control signal to an actuator such as piezoelectric actuator 200. The angle measurement method is based on the fact that although filter 220 is transparent at the wavelengths used in optical communications, filter 220 is almost totally reflective at other wavelengths, for example at visible wavelengths., As shown in FIG. 15, an incident light beam of suitable optical wavelength is provided by a light source 990 such that the incident light beam is reflected by the filter. In this configuration, a light source 990 emits a light beam 993 towards an optical filter 220, which is tilted at an angle θ with respect to incident light beam 993. The position of a reflected beam 994 is sensed by a CCD array 991. which transmits an output signal to a processor 992. Processor 992 converts the CCD array 991 output signal to a signal representing a value of a measured geometric angle θ of optical filter 220. Processor 992 then adjusts the electrical voltage supplied by power supply 90 to tilt optical filter 220 towards the desired angular position.

The feedback arrangement of FIG. 15 is only illustrative. The feedback signal sent to processor 992 could be in response to light transmitted via filter 220 to CCD array 991. Alternatively. a sensor is provided that is responsive to the movement of filter 220 itself or of some other mechanical element that is operationally associated with filter 220, for example the piezoelectric actuator (e.g. piezoelectric actuator 200) or of the support element (e.g., support element 210). The sensor could be, for example, a pressure sensor, an induction-based sensor or a capacitance-based sensor. The output signal of the sensor then is the feedback signal that is sent to processor 992.

It should be emphasized that all of the above preferred embodiments of the present invention can be operated in open-loop mode, after calibrating the applied voltage vs. the center frequency of the filter passband; or in closed-loop mode, with feedback based on measurements of the actual displacement. Further, an actuator capable of producing either a linear or an angular mechanical displacement based on any suitable technique can be substituted for the piezoelectric actuators in the various preferred embodiments of the present invention, including thermally, electrostatically, electromagnetically, or magnetically-activated actuators.

It should be further emphasized that in each of the above preferred embodiments of the present invention, the operation of the actuator is characterized by a change in shape, either longitudinally by elongation and contraction or by bending of the active actuator element, upon the application of an activation stimulus. Further, in each preferred embodiment of the present invention, the actuator is either mechanically linked or rigidly attached to the element upon which it is acting.

Moreover, for all of the preferred embodiments the configurations can be operated either in static mode. wherein a steady DC voltage is applied and the actuator changes shape longitudinally or angularly for as long as the voltage persists, or dynamic (natural frequency) mode in which an AC voltage is applied at the resonant frequency of the actuator and the attached support element, resulting in a vibrational mechanical response. It should be noted that in some applications of the dynamic mode, improved vibrational amplitude control is obtained by applying an AC voltage that is off-resonant while increasing the amplitude of the applied voltage to compensate for off-resonant operation

Although the present invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A device for tilting an optical element, comprising:
(a) a support element whereon the optical element is mounted; and
(b) at least one actuator attached to said support element for moving said support element in a manner that tilts the optical element.

2. The device of claim 1, wherein said support element is rigid.

3. The device of claim 2, wherein a first end of said support element is secured to one of said at least one actuator and wherein a second end of said support element is free.

4. The device of claim 3 wherein a first end of one of said at least one actuator is attached to a base, so that activating said one actuator tilts the optical element relative to said base.

5. The device of claim 2, further comprising:
(c) a hinge connecting said support element to one of said at least one actuator at a first end of said support element; and
(d) a mechanism for restraining movement of a second end of said support element, so that as said one actuator moves said support element, said support element tilts with respect to said one actuator at said hinge.

6. The device of claim 5 wherein an end of said one actuator opposite said hinge is attached to a base, so that activating said one actuator tilts the optical element relative to said base.

7. The device of claim 6, wherein said mechanism restrains said second end of said support element to move along a surface of said base.

8. The device of claim 1 wherein said support element is deformable.

9. The device of claim 8 wherein a first end of said support element is rigidly attached to a first end of one of said at least one actuator and movement of a second end of said support element is restrained, so that as said one actuator moves, said support element bends, thereby tilting the optical element.

10. The device of claim 9 wherein said second end of said support element and a second end of said one actuator are rigidly attached to a base, so that activating said one actuator tilts the optical element relative to said base.

11. The device of claim 8, comprising two said actuators, wherein a first end of said support element is attached to a first end of a first said actuator and a second end of said support element is attached to a first end of a second said actuator.

12. The device of claim 11 wherein a second end of said first actuator and a second end of said second actuator are attached to a base, so that activating said actuators tilts the optical element relative to said base.

13. The device of claim 1, wherein said at least one actuator is selected from the group consisting of piezoelectric actuators, thermally activated actuators, electrostatically activated actuators, electromagnetically activated actuators, and magnetically activated actuators.

14. The device of claim 13, wherein said at least one actuator is piezoelectric.

15. The device of claim 1, further comprising:
(c) for each said at least one actuator, a respective mechanism for reversibly activating said actuator.

16. The device of claim 15, wherein said at least one actuator is piezoelectric, and wherein said mechanism includes a voltage source.

17. The device of claim 15, wherein each said mechanism is operative to activate said respective actuator by inducing a change in a shape of said respective actuator.

18. The device of claim 1, further comprising:
(c) a mechanism for providing a feedback signal indicative of an operational parameter of the optical element.

19. The device of claim 18, wherein said operational parameter is an angular position of the optical element.

20. A method of filtering an incident light beam, comprising the steps of:
(a) providing a filter for passing light in the incident light beam within a predetermined characteristic wavelength band that is a function of an angle of incidence of the incident light beam upon the filter; and
(b) tilting said filter, to change said angle of incidence, by activating an actuator that is attached to a support element whereon the filter is mounted.

21. The method of claim 20 wherein said actuator changes a shape of said support element.

22. The method of claim 20, wherein said activating is effected by applying a substantially constant activation stimulus to said actuator.

23. The method of claim 20, wherein said activating is effected by applying to said actuator an activation stimulus having an amplitude which varies at a predetermined frequency.

24. The method of claim 23, wherein said frequency is a resonant frequency of an assembly including said actuator and said support element.

25. The method of claim 20 wherein said tilting is controlled by a feedback loop.

26. The method of claim 25, further comprising the step of:
(c) measuring an operational parameter of said filter; said feedback loop being based on said measured operational parameter.

27. The method of claim 26 wherein said operational parameter is an angular position of said filter.

28. The method of claim 20, wherein said tilting is effected in an open loop mode.

29. The method of claim 20 wherein said actuator is selected from the group consisting of piezoelectric actuators, thermally activated actuators, electrostatically activated actuators, electromagnetically activated actuators, and magnetically activated actuators.

30. The method of claim 20, wherein said activating of said actuator induces a change in a shape of said actuator.
